(19) United States
(12) Patent Application Publication
(10) Pub. No.: US 2005/0109086 A1
(43) Pub. Date: May 26, 2005

(54) In-line leak detector

(76) Inventors: David F. Duncan, Jacksonville, FL (US); Danny S. Mercer, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/800,903

(22) Filed: Mar. 15, 2004

Related U.S. Application Data
(60) Provisional application No. 60/455,342, filed on Mar. 17, 2003.

(51) Int. Cl. G01M 3/34

(52) U.S. Cl. 73/49.3; 73/52

(57) ABSTRACT

The invention provides an in-line leak tester apparatus for detecting leaks in packages having a flexible cover such as contact lens packages. The flexible covers move in contact with an electromechanical switch when the atmospheric pressure surrounding the package is lowered.

### RELATED APPLICATIONS

This application is a non-provisional filing of U.S. Ser. No. 60/455,342, filed on Mar. 17, 2003, a provisional patent application.

### FIELD OF THE INVENTION

The present invention relates generally to the ophthalmic lens manufacturing arts, and, in particular to a novel in-line leak detector for an ophthalmic lens manufacturing system. Automated ophthalmic lens production processes are known wherein each lens is formed by sandwiching a monomer between back curve (upper) and front curve (lower) mold structure transported in a mold cavity. The monomer is polymerized (cured) and subjected to further processing that includes but is not limited to de-molding; hydration, inspection, transfer to individual blister packages, sealing of said packages with a flexible covering, sterilization and the like. The reader may refer to U.S. Pat. No. 5,555,504 entitled PRODUCTION LINE TRACKING AND QUALITY CONTROL SYSTEM for a description of an exemplary prior art ophthalmic lens production and packaging control system, which is hereby incorporated by reference in its entirety.

With respect to packaging lenses and other products, it is extremely import to ensure that all individual blister packages are sealed to prevent bacterial contamination of the contents. Often sealed packages that are prepared on a manufacturing line are tested to determine if they are sealed by removing random lots of the packages. In one common test, representative samples of sealed packages are submerged in a chamber containing liquid visible dye and vacuum is applied. The packages are visually monitored to determine if any of the dye has seeped into the package. This type of off-line test can be time consuming and further it does not check the integrity of the majority of packages that are prepared. In addition this type of test often damages the exterior of the packages that pass the test due to the interaction of the testing liquid, and destroys the product. Therefore, an efficient method of determining whether the majority of package are adequately sealed in a time frame that is comparable with the speed of the manufacturing line, while said package is in the manufacturing line is useful.

### OBJECTIVES OF THE INVENTION

Accordingly, it is an object of the present invention to provide an in-line leak tester apparatus for packages that are sealed without off-loading the packages from the manufacturing line. Said packages have a flexible cover that moves when the atmospheric pressure surrounding the package lowered are particularly suited for this invention. A further object of the invention is to provide methods for determining whether packages are sealed. It is a further object of the invention to provide a simple and efficient apparatus and method for determining if packages are sealed where the method does not destroy the package in order to test it. It is yet still a further object of the invention to provide a simple mechanical apparatus and method for determining whether packages are sealed. Yet still a further object of the invention is to provide an apparatus and method for testing a number of packages at one time and individually determining which, if any packages are leaking. Yet still even a further object of the invention is to provide a leak detector that may be directly incorporated into a manufacturing line.

### BRIEF DESCRIPTION OF THE DRAWINGS

FIG. 1 is a top side angel view of the apparatus.

FIG. 2 is a side elevation view of an assembled switch detector assembly.

FIG. 3 is a view of the components of the leak detector sensor.

FIG. 4 is side view of assembled components of the switch detector assembly with.

FIG. 5 is view of one surface of the leak detector system.

FIG. 6 is a bottom plan view of the leak detector system.

FIG. 7 is a view of a partially assembled leak detector system.

FIG. 8 is a view of the head of the mechanical switch that contacts the package.

FIG. 9 is a view of a partially assembled mechanical switch

FIG. 10 is a view of an assembled sensor mount.

FIG. 11, is a partially assembled captive proximity sensor.

FIG. 12 is a view of an assembled switch attached to the second floor of the apparatus.

FIG. 13 is a view of an opened apparatus.

### DETAILED DESCRIPTION OF THE INVENTION AND PREFERRED EMBODIMENTS

The invention includes an apparatus for detecting leaks in at least one sealed package, wherein said package comprises a closure that is deformable when subjected to an air pressure below atmospheric pressure,

said apparatus comprising

a chamber;
   wherein said chamber may be opened and closed to allow for loading and unloading of said package,
   wherein said chamber when closed can be evacuated or returned to atmospheric pressure,
at least one mechanical switch comprising a head, a tail, and a sensor,
   wherein said head is located a first fixed distance from said deformable closure, and said tail is located a second fixed distance from said sensor, when said chamber is closed at atmospheric pressure;
and
a mechanism for determining whether a said mechanical switch is open or closed.

As used herein term “package” refers to any type of container used to store a product. As claimed, such package must have a closure, that deforms when the air pressure surrounding a sealed package is reduced below the internal pressure of the closed package and its contents. These deformable closures may be plastic, foils, composites, or other malleable materials, preferably they are foils. An embodiment of the invention is used to test ophthalmic lens packages, such as packages for contact lens. Therefore, much of the detailed description of this invention will specifically describe this embodiment.

Most contact lenses are packaged in individual blister packages having a bowl portion and a foil top, where the bowl portion is made from a hydrophobic material such as polypropylene and the foil top is made from an aluminum foil. See U.S. Pat. Nos. 4,691,820; 5,054,610; 5,337,888; 5,375,698; 5,409,104; 5,467,868; 5,515,964; 5,609,246; 5,695,049; 5,697,495; 5,704,468; 5,711,416; 5,722,536; 5,573,108; 5,823,327; 5,704,468; 5,983,608; 6,029,808; 6,044,966; and 6,401,915 for examples of such packaging, all of which are hereby incorporated by reference in their entirety. The preferred package of the invention is an ophthalmic lens package as described in U.S. Patent App. No. 2003/0029730 A1, filed on Feb. 13, 2003 and entitled “Contact Lens Package, this application is hereby incorporated by reference in its entirety.

As used herein the term “leaks” refers to an opening in the package such as openings that allows the introduction of bacterial contamination (such as a break in the hermetic seal between the deformable closure and the remaining sections of the package) or seepage of the contents of the package (such as packaging solution for a contact lens). The “chamber” of the apparatus must have all of the claimed characteristics, namely, the ability to be opened and closed, evacuated and returned to atmospheric pressure. However it is preferred that the chamber contains a first floor and a second floor, that form a sealed enclosure when these floors are fitted together. Preferably, a two floor chamber is sealed by an “O-ring” that is sandwiched between the floors when they are fitted together. Also is preferred, that one of the floors has several raised areas that protrude from the surface areas around the outside perimeter of the O-ring. These raised areas act to mechanically stop the two floors at a fixed position each time said chamber is closed and sealed against the O-ring. Said first floor preferably contains a plurality of openings designed to fit the geometry of the particular package and to accommodate a plurality of packages. Said second floor contains openings that correspond to those of said first floor. In addition, said second floor is removably attached to a plurality of mechanical switches (one for each package), where the head of each mechanical switch is positioned a first fixed distance from said deformable closure of said package. This “first fixed distance” is determined by the amount the deformable closure of a sealed package moves when the pressure in the chamber is reduced below atmospheric pressure. The maximum distance that the deformable disclosure moves under a particular reduced pressure is experimentally determined and the first fixed distance is set at between about 0% and 30% percent of that maximum distance. In the preferred embodiment of this invention the head of the mechanical switch (described below) is in contact with the deformable closure when the chamber is closed at atmospheric pressure (0%).

As used herein, “mechanical switch” refers to an assembly of individual components, a head, a tail and a sensor. Said switch has a head that is located on the moving portion of said mechanical switch. When the chamber is closed said head is positioned above an enclosed sealed package and moves in response the movement of the deformable closure. In the preferred embodiment this head is spring loaded to maintain contact with the deformable closure at atmospheric pressure. It is particularly preferred that the resistance of the spring loaded head is such that the deformable closure is flattened by the head when said chamber is closed at atmospheric pressure. Said mechanical switch has a sensor that activates (opens or closes and sends an electrical signal) when said head moves in response to movement of the deformable closure and the “tail” of the mechanical switch activates the sensor. Preferably the sensor is a non-contact capacitive proximity type, a laser, an ultrasonic or an optical sensor. In a particularly preferred embodiment of this invention the sensor is a non-contact capacitive proximity type sensor, manufactured by Omron corporation, part number E2E2-X2B1-M1.

The tail of the mechanical switch is located along the moving portion of said mechanical switch and is located closer to the sensor than the head of said mechanical switch. The movements of the tail mirror the movements of the head in response to distance the deformable closure moves when the pressure in the chamber is lower than atmospheric pressure. When the sensor is activated a mechanism notices this activation and indicates that the package is sealed. The distance between the sensor and the tail when the chamber is closed at atmospheric pressure is the “second fixed distance”. This second fixed distance is determined by the maximum distance that the deformable closure of a sealed package moves in response to reduced pressure and the sensing range of the sensor. The maximum distance that the deformable disclosure moves under a particular reduced pressure is experimentally determined. The sensing range of the sensor is the distance, extending from the sensor, that the tail must be within in order to activate the sensor. In the preferred embodiment this distance is measured axially along the line defined by the head, the tail and the sensor. However, this invention includes mechanical switch in which the orientation of the head, the tail, and the sensor may not fall on a single axis. In those instances, the sensing range is the distance extending radially from the sensor to the tail the tail must be in order to activate the sensor. The second fixed distance is set at a range from between, less than the sum of the [maximum distance the deformable closure moves at a particular pressure]+[the sensing range], to a distance within the sensing range. Preferably, the second fixed distance is set at the sum of the [maximum distance the deformable closure moves at a particular pressure]+80% of [the sensing range]. For example, if the deformable closure of a sealed package moves a maximum of 1.5 mm when subjected to an atmospheric pressure of −50 kPa, and the sensing range of the sensor is 1 mm, the second fixed distance (distance between tail and sensor) shall be set between less than about 2.5 mm and greater than about 1.0 mm, preferably less than about 2.5 mm and equal to or greater that about 2.3 mm. Most preferably the second fixed distance is set at about 2.3 mm.

The mechanism that senses whether the sensor is activated may be any analytical device that indicates to an operator or a machine that the sensor is activated. In the preferred embodiment this mechanism is a computer where closing data can be displayed, relayed or correlated with other controls of a particular manufacturing line. Preferably said mechanism would instruct another part of the manufacturing line to remove packages that are not sealed. Preferably this apparatus is incorporated in a manufacturing line and as such it must test packages at the speed of the manufacturing line.

Further the invention includes a method for detecting leaks in at least one sealed package, wherein said package comprises a closure that is deformable when subjected to an air pressure below atmospheric pressure,

said method comprising

loading said package to a chamber;
   wherein said chamber may be opened and closed to allow for loading and unloading of said package,
   wherein said chamber when closed can be evacuated or returned to atmospheric pressure,
   wherein said chamber comprises at least one mechanical switch, comprising a head, a tail, and an sensor,
      wherein said head is located a first fixed distance from said deformable closure, and said tail is located a second fixed distance from said sensor, when said chamber is closed at atmospheric pressure;
closing said chamber and reducing the pressure in said chamber to a level below the internal pressure of said package and its contents;
determining whether said mechanical switch is open or closed.

As used herein the terms package, deformable closure, chamber, mechanical switch, leaks, head, tail, sensor, mechanism, first fixed distance, and second fixed distance all have their aforementioned meanings and preferred ranges. The term “closing” refers to any device that closes the chambers, particularly, said first floor and said second floor. One of said floors can be stationary and it is preferred that said first floor is stationary and said second floor moves. Pressure is reduced in the chamber by applying a vacuum through an orifice in said chamber. In the preferred embodiment said reduced pressure is greater than or equal to −70 kPa. In some instances, if there is a leak in a contact lens package, reducing atmospheric pressure will cause a flexible contact lens to plug the leak and give a false reading that the package is sealed. Therefore it particularly preferred the pressure in the chamber is increased to level greater than the internal pressure of the package and its contents, before the pressure in the chamber is reduced to a level below the internal pressure of the package and its contents.

Determining whether said mechanical switch is opened or closed can be accomplished by any of a number of sensors. It is preferred that once it is determined that said sensor is activated that this information is transferred to a computer where said data can be displayed, relayed or correlated with other controls of a particular manufacturing line. Preferably said method instructs another parts of the manufacturing line to remove packages that are not sealed. Preferably this method is incorporated in a manufacturing line and as such it must test packages at the speed of the manufacturing line. More, preferably, the method is complete within less than 10 seconds for between 1 and 12 packages, most preferably within less than 5 seconds for between 1 and 12 packages.

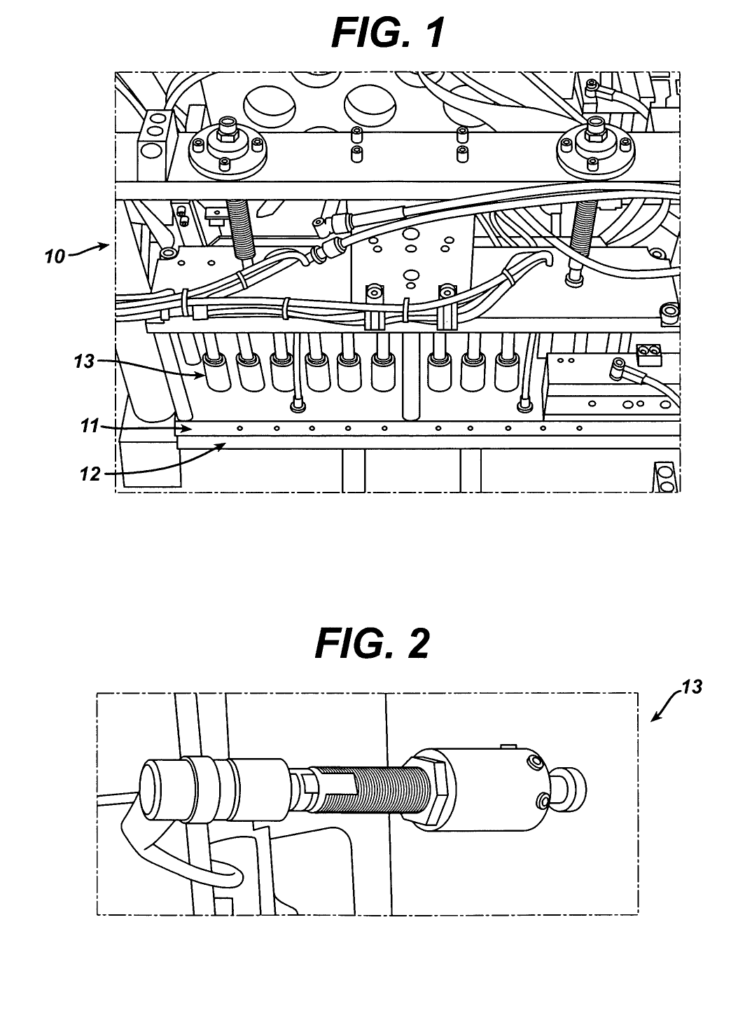

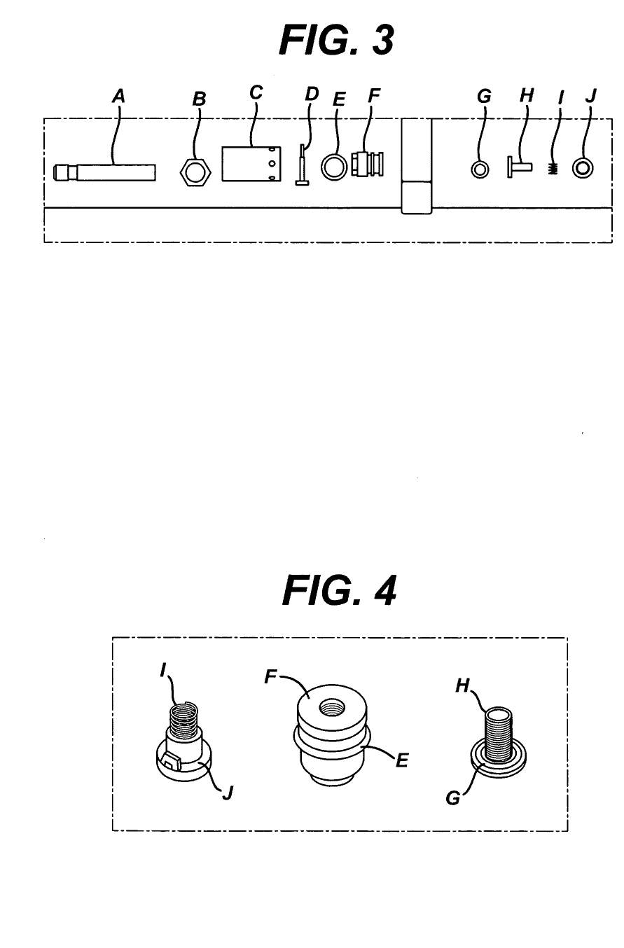

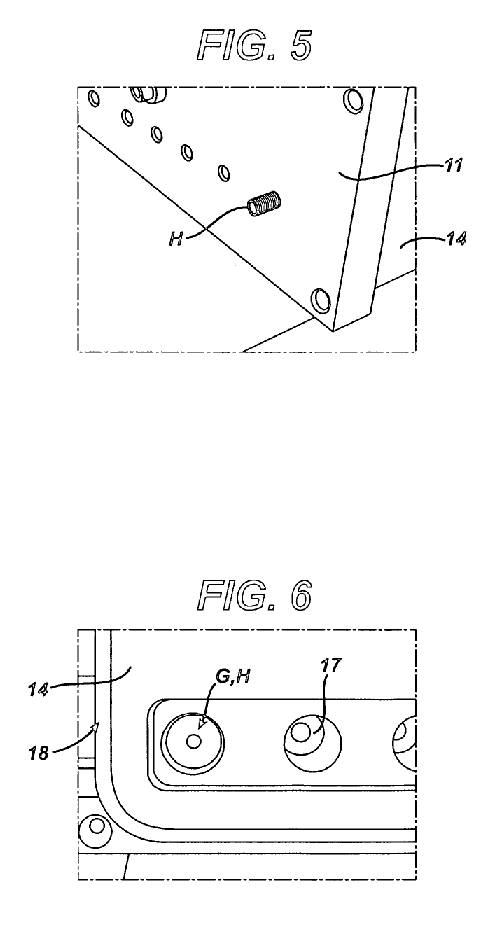

An example of an embodiment of the invention is illustrated in greater detail in reference to the following figures. FIG. 1, illustrates a diagrammatic view of an assembled apparatus of the invention 10 is shown, a first floor 12, a second floor 11, where mechanical switches 13 are removably attached to the second floor 11. FIG. 2 illustrates a view of a fully assembled mechanical switch 13 that is not attached to second floor 11. FIG. 3 illustrates unassembled parts of the mechanical switch 13. A is a proximity sensor, B is a sensor lock nut, C is a sensor mount, D is a flag, E is an O-ring, F is a shaft nut, G is an O-ring, H is a threaded shaft, I is a spring and J is a head. As illustrated by FIG. 4, the mechanical switch is assembled as follows: place O-ring E on shaft nut F, place O-ring G on shaft H, and place spring I on head J. Install threaded shaft H through an orifice in second floor 11 from the surface that will face the package 14, of said second floor 11, extending through to the opposite surface 15, as shown by FIG. 5. FIG. 6 shows surface 14 with threaded shaft H and O-ring G installed. Further, FIG. 6 shows an orifice 17, this orifice is of the type that was used for the insertion of threaded shaft H. FIG. 6 also shows channel 18, which is used to house an O-ring (not shown) that seals the first floor 12 to the second floor 11 when vacuum is applied.

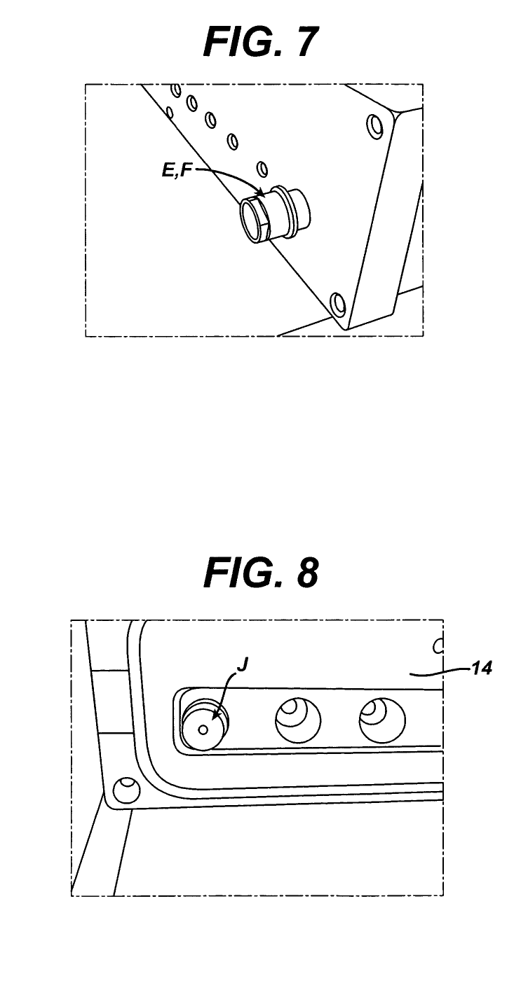

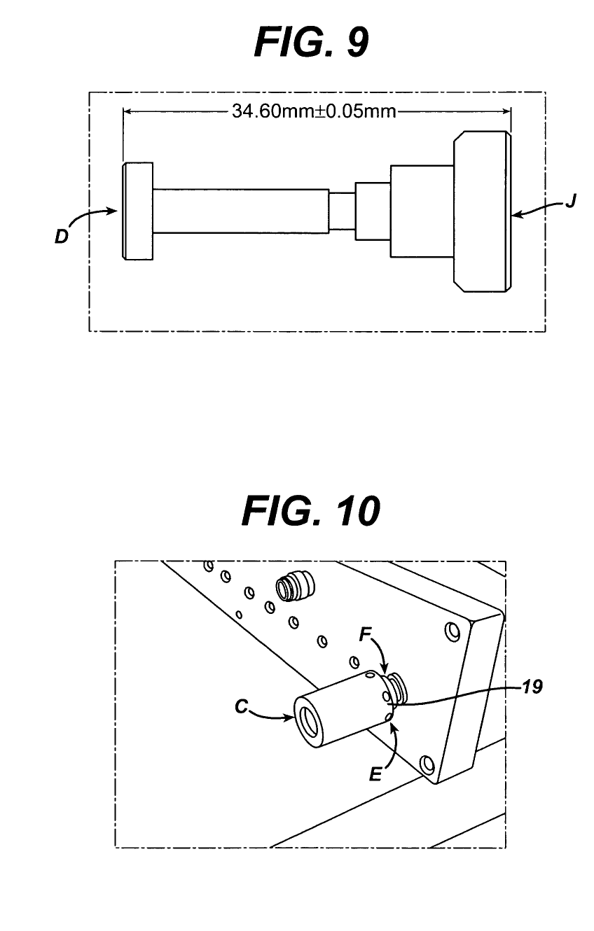

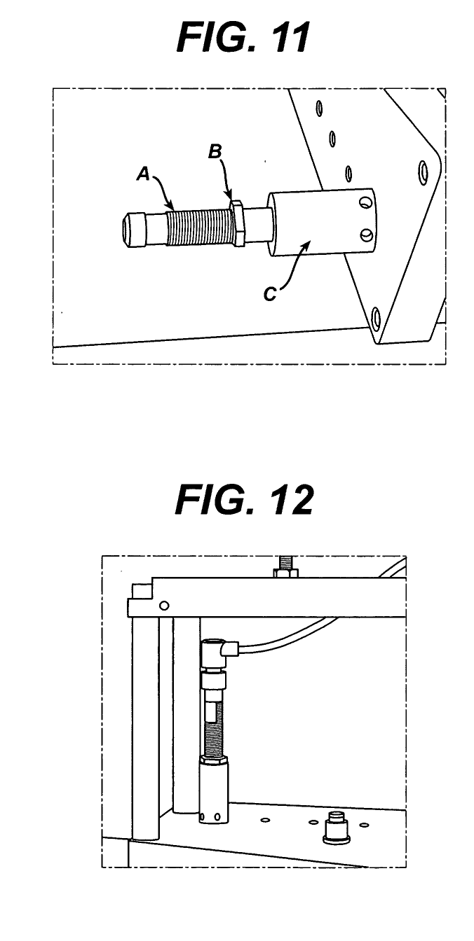

To continue assembly screw shaft nut F with O-ring E to threaded shaft H as illustrated by FIG. 7. Insert flag D into shaft nut F and the threaded shaft of flag D will extend through shaft nut F and emerge on surface 14 of second floor. Screw head J with spring I onto the threaded shaft of flag D as shown in FIG. 8. For the contact lens package of this embodiment, it is critical that the distance between the tail of flag D and the bottom of head J be 34.60 mm±0.05 mm, as shown in FIG. 9. Lubricate sensor mount C and install it over shaft nut F. Tighten set screws 19 to seat sensor mount C, as shown in FIG. 10. Screw lock nut B onto Sensor A and screw sensor A into sensor mount C, as shown in FIG. 11. Screw lock nut B towards surface 15 until it touches sensor mount C. Attach sensor cable 20 to the top of captive proximity sensor A, as shown in FIG. 12.

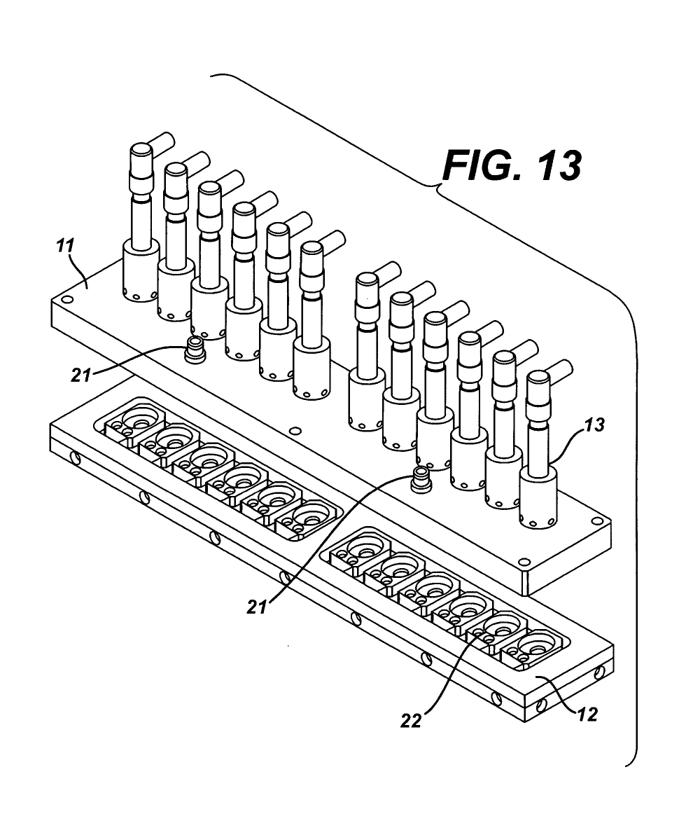

A view of the opened apparatus of the invention is illustrated by FIG. 13. Ports 21 for the regulation of pressure are shown on second floor 11. Molded orifices 22 (used to hold the individual packages) are displayed in first floor 12.

This apparatus 10 is one of the manufacturing stations of a contact lens manufacturing line. It operates as follows. Sealed packages are loaded to first floor 12 by a mechanical means. Said second floor 11 moves downwardly to seat with said first floor 12. The air pressure in the chamber is reduced by pulling a vacuum via ports 21. Although not shown, there are two channels 18 (for O-rings) on surface 14 of said second plate 11. Each channel surrounds a perimeter of second plate 11 to enclose six adjacent molded indentations 22 into one pressurized chamber unit. A transducer device (not shown) monitors the pressure in each pressurized chamber unit over a period of time. If a constant pressure is reached over said period or time, signals from each of the twelve mechanical switches are read to determine whether they are closed or open. A closed switch means that the package is sealed, an open switch means there is a leak. This information is transferred to a secondary processing station where it is displayed, recorded or coordinated with other processing steps. Since each package has its own sensor, faulty packages are rejected further at a subsequent processing station.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for detecting leaks in at least one sealed package, wherein said package comprises a closure that is deformable when subjected to an air pressure below atmospheric pressure,
said apparatus comprising
a chamber;
wherein said chamber may be opened and closed to allow for loading and unloading of said package,
wherein said chamber when closed can be evacuated or returned to atmospheric pressure,
at least one mechanical switch comprising a head, a tail, and a sensor,
wherein said head is located a first fixed distance from said deformable closure, and said tail is located a second fixed distance from said sensor, when said chamber is closed at atmospheric pressure;
and
a mechanism for determining whether a said mechanical switch is open or closed.

2. The apparatus of claim 1 wherein said head is positioned on the surface of said deformable closure when said chamber is closed under atmospheric pressure.

3. The apparatus of claim 1 comprising a plurality of mechanical switches.

4. The apparatus of claim 1 wherein said sensor is selected from the group consisting of non-contact capacitive proximity type, a laser, an ultrasonic and an optical sensor.

5. The apparatus of claim 1 wherein said sensor is a non-contact capacitive proximity sensor.

6. The apparatus of claim 5 wherein said chamber comprises a first floor and a second floor wherein said second floor comprises at least on mechanical switch.

7. The apparatus of claim 6 where said first floor comprises molded indentations for holding said packages.

8. The apparatus of claim 1 wherein said packages are ophthalmic lens packages.

9. The apparatus of claim 2 wherein said chamber comprises a first floor and a second floor, wherein said second floor comprises a plurality of mechanical switches and a port for attachment of a vacuum pump.

10. The apparatus of claim 1 wherein said first fixed distance is about 0 to about 30%.

11. The apparatus of claim 1 wherein said second fixed distance is about the sum of the maximum amount the deformable closure moves at a particular pressure +80% of the sensing range.

12. A method for detecting leaks in at least one sealed package, wherein said package comprises a closure that is deformable when subjected to an air pressure below atmospheric pressure,
said method comprising
loading said package to a chamber;
wherein said chamber may be opened and closed to allow for loading and unloading of said package,
wherein said chamber when closed can be evacuated or returned to atmospheric pressure,
wherein said chamber comprises at least one mechanical switch, comprising a head, a tail, and a sensor,
wherein said head is located a first fixed distance from said deformable closure, and said tail is located a second fixed distance from said sensor, when said chamber is closed at atmospheric pressure;
closing said chamber and reducing the pressure in said chamber to a level below the internal pressure of said package and its contents;
determining whether said mechanical switch is open or closed.

13. The method of claim 12 wherein said package is a contact lens package.

14. The method of claim 12 wherein said pressure is reduced to about greater than or equal to −70 kPa.

15. The method of claim 12 wherein said head is spring loaded against the surface of said deformable closure when said chamber is closed under atmospheric pressure.

16. The method of claim 12 wherein the method is complete in less than 10 seconds.

17. The method of claim 12 wherein the method is complete in less than 5 seconds.

18. A method for detecting leaks in at least one sealed package, wherein said package comprises a closure that is deformable when subjected to an air pressure below atmospheric pressure,
said method comprising
loading said package to a chamber;
wherein said chamber may be opened and closed to allow for loading and unloading of said package,
wherein said chamber when closed can be evacuated or returned to atmospheric pressure,
wherein said chamber comprises at least one mechanical switch comprising a head, a tail, and a sensor,
wherein said head is located a first fixed distance from of said deformable closure, and said tail is located a second fixed distance from said sensor, when said chamber is closed at atmospheric pressure;
closing said chamber and increasing the pressure in said chamber to a level above the internal pressure of said package and its contents;
reducing the pressure in said chamber to a level below the internal pressure of said package and its contents;
determining whether said mechanical switch is open or closed.
